(19) United States
(12) Patent Application Publication
(10) Pub. No.: US 2009/0094334 A1
(43) Pub. Date: Apr. 9, 2009

(54) GATEWAY WITH TRANSPARENT MAIL RELAY

(76) Inventor: Anders Eriksson, Linkoping (SE)

Correspondence Address: ERICSSON INC., 6300 LEGACY DRIVE, M/S EVR 1-C-11, PLANO, TX, 75024, US

(21) Appl. No.: 11/866,504

(22) Filed: Oct. 3, 2007

(51) Int. Cl. G06F 15/16

(52) U.S. Cl. 709/206

(57) ABSTRACT

A transparent mail relay is provided at a gateway between networks using different addressing schemes. The transparent mail relay receives mail messages from a mail client in a first one of the networks, inserts trace information into the header of the mail message, and forwards the mail message to a mail server in the other network. Mail protocol commands and replies are passed transparently by the mail relay without alteration.

### FIELD OF THE INVENTION

The present invention relates generally to the delivery of electronic mail messages over communication networks and, more particularly, to a transparent mail relay that transparently forwards mail messages from a mail system in a first network to a mail system in a second network.

### DESCRIPTION OF THE RELATED ART

The Simple Mail Transfer Protocol (SMTP) is the predominant protocol used in the Internet to transfer electronic mail. When an email message is sent, the email message may pass through a number of mail transfer agents (MTAs) on its path from the sender to the ultimate recipient. Each MTA adds trace information to the header of the mail message. In the SMTP protocol, the trace information comprises the name and IP address of the host from whom the message was received. This information is placed in a received header that is pre-pended to the message by each MTA. A new received header is added by each MTA in the path from the sender to the ultimate recipient. This information allows the path of the email message to be traced back to the sender. The trace information is used to detect and break routing loops and to debug mail delivery problems.

Problems may arise when the mail message traverses a gateway connecting to networks using different addressing schemes. This situation may occur, for example, when a private IP network connects via the gateway to a public IP network, or where an IPv4 network connects via a gateway to an IPv6 network. Even though the SMTP may be supported in both networks, some trace information is lost when the mail data packets cross from one network to the other. When an MTA in one network receives the mail via the gateway from an MTA in the other network, the mail message will appear to the receiving MTA as if it originated from the gateway. Thus, the MTA will insert the IP address of the gateway into the headers of the mail message as the trace information. This can lead to problems in detecting routing loops and in troubleshooting mail delivery problems.

One solution to this problem is to deploy a dual-hosted MTA at the gateway that straddles the border between the two networks. This solution can be prohibitively expensive, particularly when high availability requirements must be met. The addition of the MTA and associated data storage significantly increases the capital cost and maintenance expenses associated with the gateway.

### SUMMARY

The present invention provides a mail relay for a gateway between first and second networks using different addressing schemes. The gateway comprises a first interface for connecting to the first network, a second interface for connecting to the second network, an address translator for translating addresses of data packets traversing the gateway, and a transparent mail relay for inserting trace information into mail messages traversing the gateway. In one exemplary embodiment, a packet selector directs email traffic to the mail relay. The transparent mail relay monitors mail transactions between a mail client in the first network and a mail server in the second network. When the mail client sends a mail message to the mail server, the transparent mail relay inserts the trace information into the mail message and forwards the mail message to the server. The trace information inserted by the transparent mail relay is useful in detecting and breaking routing loops and troubleshooting mail delivery problems. Mail protocol command and replies are passed transparently by the mail relay without alteration.

### BRIEF DESCRIPTION OF THE DRAWINGS

FIG. 1 illustrates an exemplary mail delivery system.

FIG. 2 illustrates an exemplary exchange between a mail client and a mail server.

FIG. 3 illustrates the transmission of a mail message across a gateway between networks using two different addressing schemes.

FIG. 4 is a functional block diagram of a gateway having a transparent mail relay.

FIG. 5 is a functional block diagram of a transparent mail relay.

FIG. 6 illustrates an exemplary method implemented by a gateway having a transparent mail relay.

### DETAILED DESCRIPTION

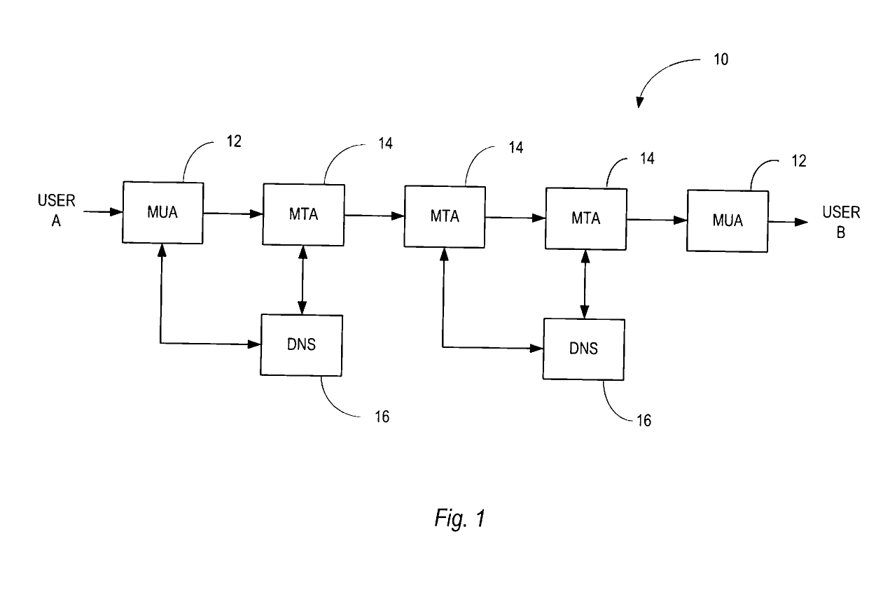

Referring now to the drawings, FIG. 1 illustrates an exemplary mail delivery system 10. The mail delivery system 10 comprises a plurality of mail user agents 12 and mail transfer agents 14. The mail user agents 12 interface with the user's mail clients. The mail user agents 12 are normally thought of as the sources and targets of mail messages. The mail transfer agents 14 transport the mail messages through a network from the sender's mail user agent 12 to the final recipient's mail user agent 12.

On its path from the sender to the final recipient, a mail message may pass through a number of mail transfer agents 14. The Transport Control protocol (TCP) is typically used for transport of the mail messages. Each mail user agent 12 and mail transfer agent 14 in the path determines the next hop in the path by querying a domain name server 16. The domain name server 16 maintains a list of mail exchanges and corresponding IP addresses. The mail user agents 12 and mail transfer agents 14 provide the email address of the final recipient to the domain name server 16 in a DNS request. In the response, the DNS 16 provides the mail user agent 12 or mail transfer agent 14 with the host name and address of a mail system (i.e., a message user agent 12 or mail transfer agent 14) that can receive the message. The mail message is passed along in this manner until it reaches the recipient's mail user agent 12.

There are a number of protocols supporting mail transport over a communication network. The Simple Mail Transfer Protocol (SMTP) is probably the most common protocol used today for transferring mail through a network. The SMTP protocol provides a simple protocol for transferring mail messages from an SMTP client to an SMTP server. In the mail delivery architecture shown in FIG. 1, a message user agent 12 or message transfer agent 14 acts as an SMTP server when it receives a message, and acts as an SMTP client when it forwards the message to the next mail system.

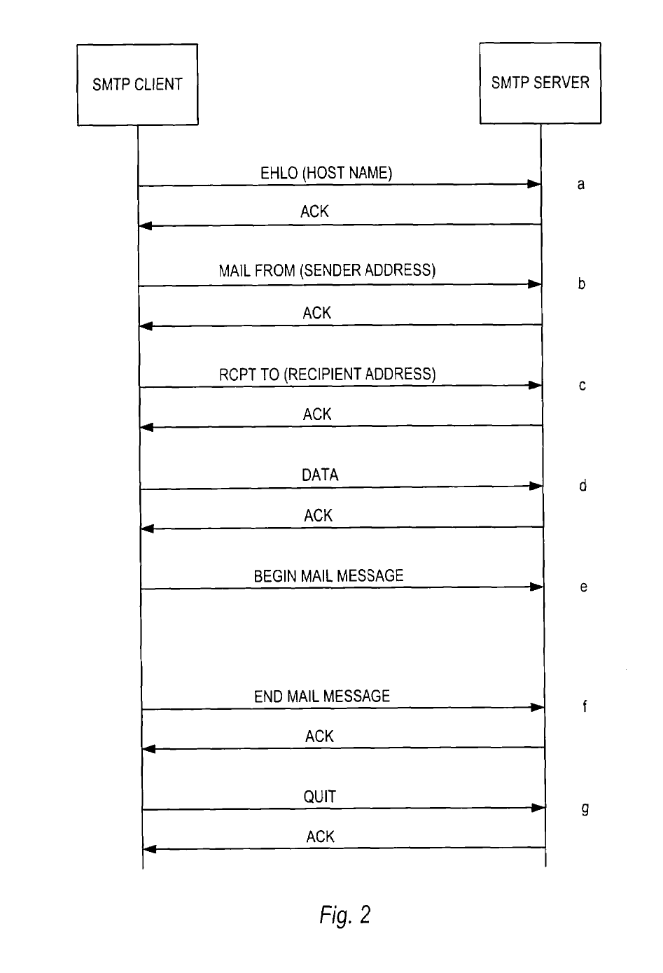

FIG. 2 illustrates an exemplary exchange between an SMTP client and SMTP server. The SMTP client initiates transfer of a mail message by sending the EHLO or HELO command to the server (step a). The SMTP client identifies itself by inserting the host name of the mail system into the EHLO command. After receiving an acknowledgement from the SMTP server, the SMTP client sends the “Mail From” command (step b) and “Rcpt To” command (step c) to the SMTP server. The “Mail From” command identifies the sender of the email message and the “Rcpt To” command identifies the final recipient of the email message. After these commands are acknowledged, the SMTP client sends a data command (step d) and begins transmitting the content of the mail message to the SMTP server (step e). The SMTP client signals the end of the mail message by transmitting a single period on the last line of the transmission (step f. After the SMTP server acknowledges receipt, the SMTP client sends the “Quit” command to end the SMTP session (step g).

According to the SMTP protocol, each mail system (e.g. MUA 12 or MTA 14) that transfers the mail message on the path from the sender to the receiver must insert trace information into the header of the mail message. The term “mail message” as used herein refers to the information communicated from one user to another. The mail message includes a message body and a message header. Typically, each mail system that transfers the message pre-pends a new “Received” header to the mail message. The “Received” header identifies the mail system from which the message was received. The identification typically includes the host name and IP address of the mail system sending the mail message. The trace information is useful in detecting and breaking routing loops, and in troubleshooting mail delivery problems within the mail delivery system 10.

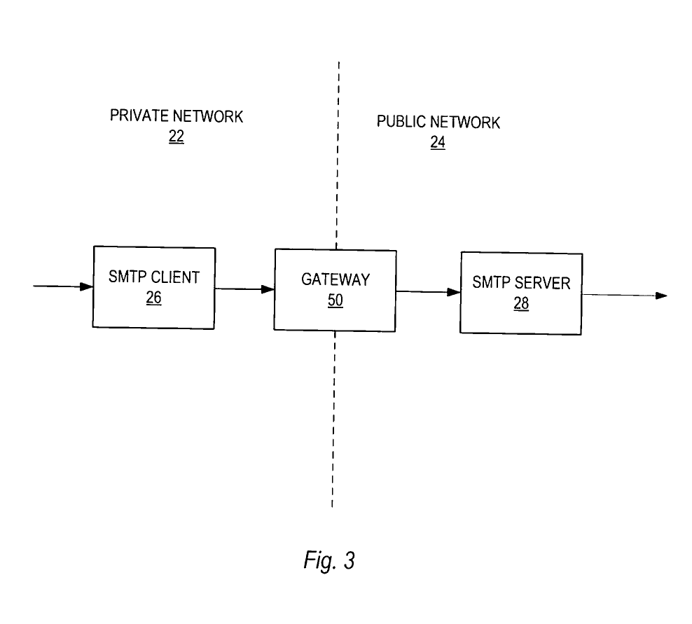

While the SMTP protocol has proven to be robust in practice, there are certain circumstances where the trace information may be inadequate or misleading. FIG. 3 illustrates one scenario that may lead to problems in routing loop detection. FIG. 3 shows two networks 22, 24 that represent different addressing realms. In the exemplary embodiment, network 22 comprises a private network and employs private IP addresses. Network 24 is a public network and employs public IP addresses. A gateway 50 connects the private network 22 to the public network 24. A mail system 26 in the private network 22 functioning as an SMTP client sends mail messages through the gateway 50 to a mail system 28 in the public network 24, functioning as an SMTP server. The SMTP client 26 sends a DNS request to a DNS 16 (FIG. 1), which may reside in either the private network 22 or in the public network 24. In response, the domain name server 16 provides the address of the SMTP server 28 to the SMTP client 26. The gateway 50 translates the addresses for data packets passing through the gateway 50, but is transparent to the mail systems 26 and 28. When mail system 26 receives a mail message, it inserts trace information into the mail message and forwards the mail message to mail system 28 via the gateway 50. Mail system 28, in turn, inserts trace information into the mail message and forwards the mail message to the next mail system in the delivery path.

In the scenario illustrated in FIG. 3, the IP address of the gateway 50 will be the apparent address of the mail system 26 to entities residing in the public network 24. Thus, the mail system 28 will insert the address of the gateway 50 into the ‘Received’ header of the mail message as the trace information. Thus, it is not possible to trace back the mail message to the mail system 26. This break in the trace information may make it difficult to detect routing loops and troubleshoot mail delivery problems. A similar situation could also arise at a gateway between IPv4 and IPv6 networks.

According to one exemplary embodiment of the present invention, a transparent mail relay is provided at a gateway 50 between networks using different addressing schemes. The transparent mail relay receives mail messages sent by an SMTP client 26 in a first one of the networks, inserts trace information into the header of the mail message, and forwards the mail message to an SMTP server 28 in the other network. SMTP commands and replies are passed transparently by the mail relay without alteration. The mail relay is transparent to the SMTP client 26 and SMTP server 28, except for the received header. The SMTP client 26 behaves as if it is communicating directly with the SMTP server 28. Conversely, the SMTP server 28 behaves as if it is communicating directly with the SMTP client 26. The SMTP client 26 and SMTP server 28 may remain completely unaware of the mail relay's presence at the gateway 50.

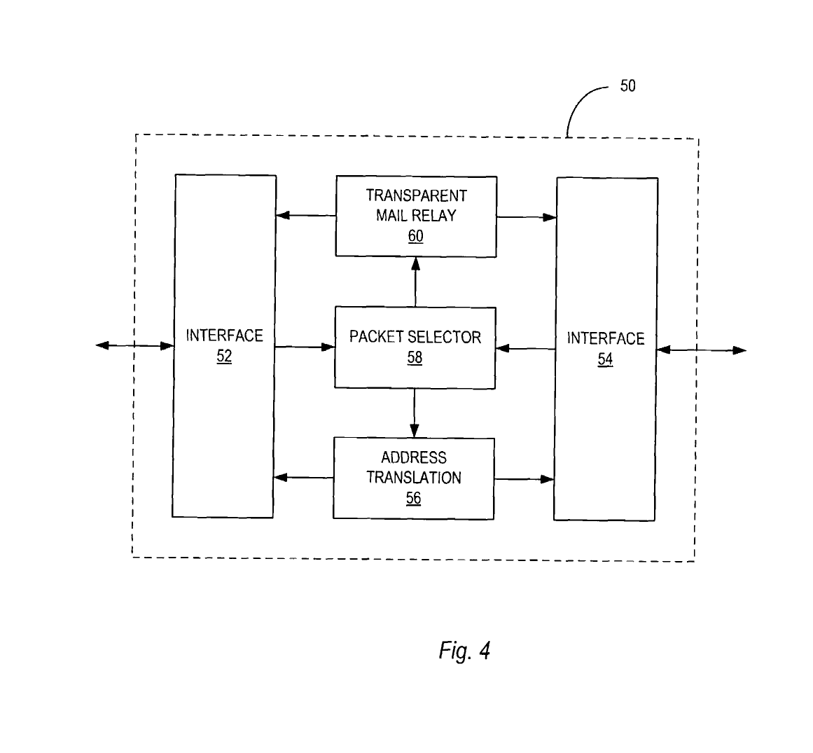

FIG. 4 illustrates an exemplary gateway 50 including a transparent mail relay 60 according to one exemplary embodiment. The gateway 50 comprises a first interface 52, a second interface 54, an address translation module 56, a packet selector 58, and a transparent mail relay 60. The first interface 52 connects the gateway 50 to a first network that uses a first addressing scheme, such as a private network or IPv4 network. The second interface 54 connects the gateway 50 to a second network that uses a second addressing scheme, such as a public network or IPv6 network. The address translation module 56 translates addresses of TCP packets that pass through the gateway 50 in a conventional manner. Because address translation is well-known in the art and is not material to the present invention, a detailed discussion of address translation is omitted. The packet selector 58 inspects TCP packets that pass through the gateway 50 and directs TCP packets containing SMTP protocol units, referred to herein as mail data packets, to the transparent mail relay 60. The mail relay 60 examines and processes mail data packets. When the SMTP client 26 sends a mail message through the gateway 50, the mail relay 60 inserts trace information into the header of the mail message and forwards the mail message to the SMTP server 28.

All TCP packets entering the gateway 50 first pass to the packet selector 58. The packet selector 58 detects mail data packets and directs them to the mail relay 60. All other TCP packets are passed to the address translation module 56. The address translation module 56 translates the addresses of the TCP packets and forwards the TCP packets. Address translation is not performed on mail data packets because the TCP protocol for SMTP packets is terminated at the gateway 50 as hereinafter described.

The packet selector 58 can detect mail data packets in several ways. One technique is to examine the destination address of the data packets. Most mail data packets are directed to port 25 of the host specified by the destination address. If the TCP packet is directed to port 25, it may be directed to the mail relay 60. Also, the packet selector 58 may also look for keywords or phrases in the TCP packet. For example, the packet selector 58 may examine the TCP packets for typical SMTP commands. Other known methods of packet identification may also be used.

In one exemplary embodiment, the mail relay 60 is a stateless mail relay. The mail relay 60 does not store SMTP session information, nor does it store copies of the mail messages passing through the gateway 50. Thus, it requires only limited memory resources. The mail relay 60 does not act as an SMTP client 26 or SMTP server 28. It does not assume any responsibility for the delivery of SMTP protocol units and does not provide any notification to the SMTP client 26 in case of failure of delivery. Its primary function is to insert trace information into mail messages to facilitate loop detection and other mail delivery problems. Thus, the mail relay 60 functions in a manner similar to a TCP relay. It blindly forwards SMTP protocol units sent by a SMTP client to an SMTP server, and adds a Received” header to mail messages at the right point in the SMTP transaction.

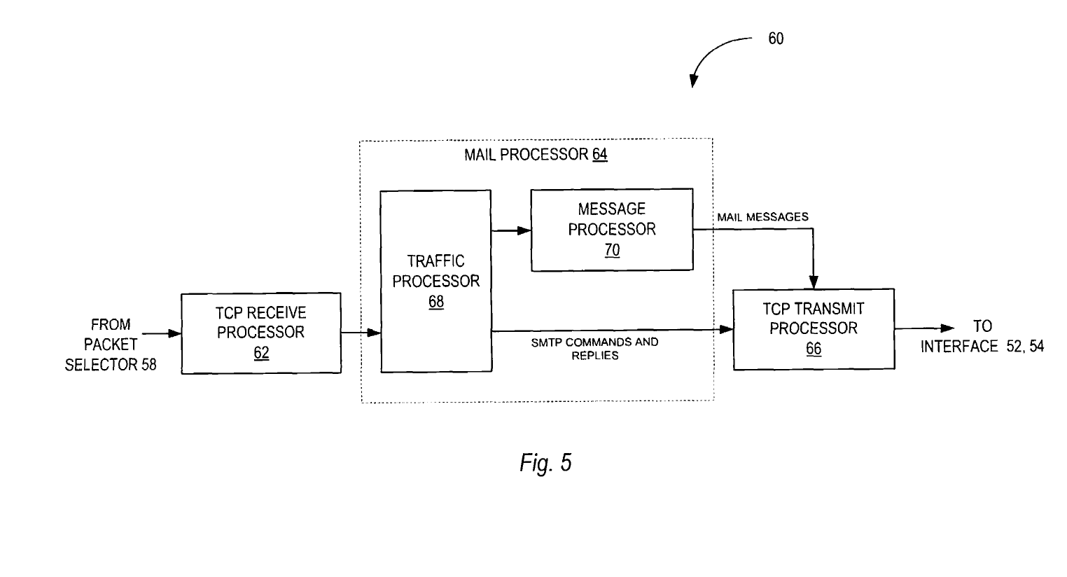

FIG. 5 illustrates the functional components of an exemplary transparent mail relay 60. The transparent mail relay 60 comprises a TCP receive processor 62, mail processor 64, and TCP transmit processor 66. The TCP receive processor 62 terminates the TCP protocol at the gateway 50, extracts SMTP protocol units from the received TCP packets, and passes all SMTP protocol units to the mail processor 64. The mail processor 64 processes the SMTP protocol units as described herein. After processing, the SMTP protocol units are passed to the TCP transmit processor 66, which reinserts the SMTP protocol units into TCP packets and forwards the TCP packets to the SMTP server 28.

The TCP mail processor 64 includes a traffic processor 68 and message processor 70. The traffic processor 68 examines the SMTP protocol units and directs mail messages to the message processor 70. All other SMTP protocol units, such as SMTP commands and replies, are passed directly to the TCP transmit processor 66 without alteration and, from there, forwarded to the SMTP server 28. The traffic processor 68 monitors the SMTP dialog between the SMTP client 26 and SMTP server 28 and transparently passes all SMTP traffic to the TCP transmit processor 66 until the SMTP dialog enters the DATA phase. Once the DATA phase of the SMTP dialog begins, the SMTP traffic, i.e., the mail message, is redirected to the message processor 70 until the DATA phase of the SMTP transaction is complete. The message processor 70 inserts trace information into the header of the redirected mail message as previously described and sends the mail message to the TCP transmit processor 66. The TCP transmit processor inserts the SMTP protocol units received from both the traffic processor 68 and message processor 70 into TCP packets and forwards the resulting TCP packets to the SMTP server 28.

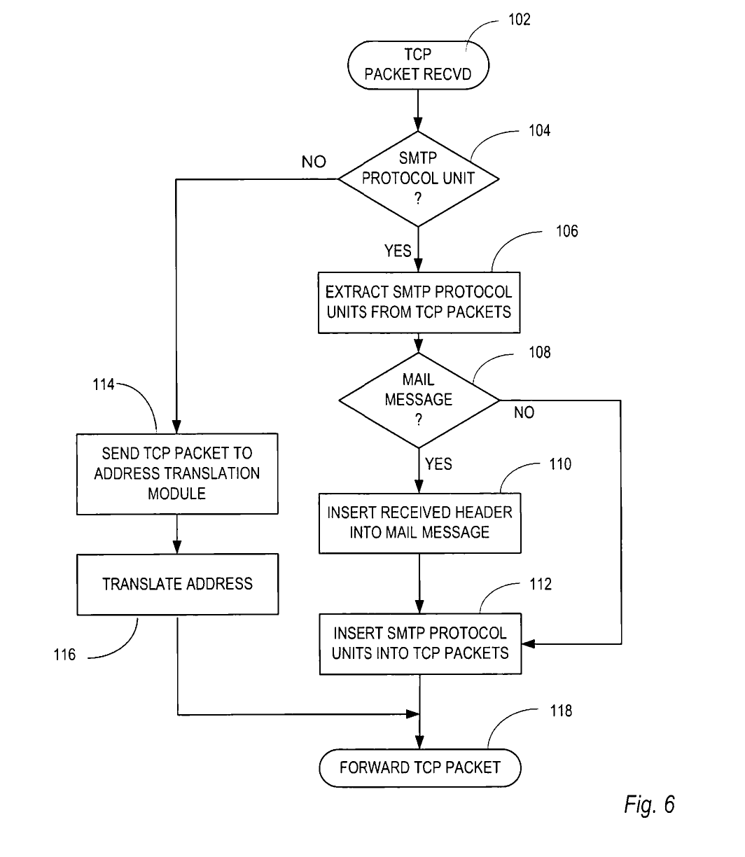

FIG. 6 illustrates a method implemented by the gateway 50 in one exemplary embodiment. The method begins when a TCP packet is received at the gateway (block 102). All TCP packets entering the gateway 50 are initially directed to the packet selector 58. The packet selector 58 examines the TCP packets to determine whether the packets contain SMTP protocol units (block 104). TCP packets containing SMTP protocol units are directed to the mail relay 60. All other TCP packets are passed to the address translation module 56 (block 114) where the destination address is translated (block 116). The translated TCP packet is then forwarded (block 118).

The mail processor 64 processes TCP packets containing SMTP protocol units or portions thereof. The TCP receive processor 62 in the mail relay 60 extracts the SMTP protocol units from the TCP packets and sends the SMTP protocol units to the mail processor 64 (block 106). The traffic processor 68 in the mail processor 64 inspects SMTP traffic between an SMTP client 26 and SMTP server 28 to determine when the message transmission begins. The traffic processor 68 separates mail messages from SMTP commands and replies (block 108). It directs mail messages to the message processor 70 and transparently passes SMTP commands and replies to the TCP transmit processor 66. The message processor 70 inserts trace information into the headers of mail messages (block 110). The trace information may comprise, for example, the host name and IP address of the mail system (e.g. SMTP client) from which the mail message was received. In SMTP, the trace information is pre-pended to the mail message as a new ‘Received’ header. After inserting the trace information, the mail processor 70 sends mail messages to the TCP transmit processor 66 for delivery to the SMTP server 28. All SMTP protocol units are inserted into TCP packets by the TCP transmit processor (block 112) and forwarded to the SMTP server 28 (block 118). The procedure is repeated each time a packet is received at the gateway 50.

The gateway 50 may comprise a specially programmed computer with conventional network interfaces. The gateway computer may include one or more processors to carry out the functions of the gateway 50 as described herein. More specifically, the address translation module 56, packet selector 58, and mail relay 60 can all be implemented by one or more microprocessors, microprocessors, hardware circuits, or a combination thereof.

By inserting trace information at the gateway 50, the ability to detect routing loops and other mail delivery problems is improved. The mail relay 60 does not require extensive mail storage resources conventionally present in high availability mail systems to store mail messages. Thus, the mail relay 60 can be efficiently and economically implemented at a gateway 50 with relatively low costs and low complexity. The mail relay 60 is also compatible with current SMTP protocols and requires no modifications at the SMTP client or SMTP server.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A gateway comprising:
a first interface for connecting to a first network using a first addressing scheme;
a second interface for connecting to a second network using a second addressing scheme;
a packet selector to separate mail data packets from other data packets and to direct said mail data packets to a transparent mail relay;
an address translator for translating addresses of said other data packets traversing said gateway; and
a transparent mail relay including a mail processor for processing said mail data packets, said mail processor comprising:
a traffic processor configured to transparently relay mail protocol commands and replies sent between a first mail system in said first network and a second mail system in said second network, and to redirect mail messages to a message processor before said mail messages are relayed to said second mail system, and
a message processor configured to insert trace information into said mail message before said mail messages are forwarded to said second mail system.

2. The gateway of claim 1 wherein said transparent mail relay implements Simple Mail Transfer Protocol (SMTP).

3. The gateway of claim 2 wherein the transparent mail relay is stateless and does not maintain SMTP session information.

4. A method of transferring mail though a gateway between a first mail system and a mail system, said method comprising:
receiving data packets at a gateway and separating mail data packets from other data packets;
translating the addresses of said other data packets received at said gateway; and
processing said mail data packets by a mail processor at said gateway, said processing comprising:
inserting trace information into mail messages sent from said first mail system to said second mail system; and
transparently relaying mail protocol commands and replies between said first and second mail systems.

5. The method of claim 4 wherein said mail protocol packets comprise Simple Mail Transfer Protocol (SMTP) packets.

6. The method of claim 5 wherein said mail processing is performed by a stateless mail relay without maintaining SMTP session information.

7. A transparent mail relay for a gateway between first and second networks, said transparent mail relay comprising:
a traffic processor configured to:
transparently relay SMTP commands and replies between a first mail system in said first network and a second mail system in said second network; and
redirect mail messages to a message processor before said mail messages are relayed to said second mail system; and
a message processor configured to insert trace information into said mail messages before said mail messages are forwarded to said second mail system.

8. The transparent mail relay of claim 7 wherein said transparent mail relay implements Simple Mail Transfer Protocol (SMTP).

9. The transparent mail relay of claim 8 wherein the transparent mail relay is stateless and does not maintain SMTP session information.
